(19) United States
(12) Patent Application Publication
(10) Pub. No.: US 2015/0353013 A1
(43) Pub. Date: Dec. 10, 2015

(54) DETECTION APPARATUS

(71) Applicant: DENSO CORPORATION, Kariya-city (JP)

(72) Inventor: HIRONORI SATO, Toyota-shi (JP)

(21) Appl. No.: 14/734,114

(22) Filed: Jun. 9, 2015

(30) Foreign Application Priority Data
Jun. 10, 2014 (JP) 2014-119703

(51) Int. Cl. B60R 1/00; G06K 9/00; H04N 5/232

(52) U.S. Cl. CPC B60R 1/00; H04N 5/23222; G06K 9/00791; B60R 2300/303

(57) ABSTRACT

A detection apparatus includes an acquisition section which acquires a plurality of images taken by an imaging unit whose position and direction are changed, the images being subject to different image quality settings, and a detection section which detects a shielded region, in which imaging is blocked, in the image taken by the imaging unit based on the plurality of images acquired by the acquisition section.

### CROSS-REFERENCE TO RELATED APPLICATION

This application is based on and claims the benefit of priority from earlier Japanese Patent Application No. 2014-119703 filed Jun. 10, 2014, the description of which is incorporated herein by reference.

### BACKGROUND

1. Technical Field

The present invention relates to a detection apparatus detecting an abnormality of an image taken by a camera.

2. Related Art

A technique is known which is for acquiring images, which are taken by a camera, at predetermined time intervals and averaging the images to detect an abnormality based on the difference between images newly acquired and the averaged image (e.g. JP-A-7-296168).

However, according to the method disclosed in JP-A-7-296168, difference always arises between the averaged image and the newly acquired image in an environment in which the taken images successively vary. Thus, an abnormality may be erroneously detected. Accordingly, this method cannot reliably detect an abnormality of an image taken by a camera or the like, which takes images around a vehicle to perform driving support.

### SUMMARY

An embodiment provides a detection apparatus which reliably detects an abnormality of an image taken by an imaging unit.

As an aspect of the embodiment, a detection apparatus includes: an acquisition section which acquires a plurality of images taken by an imaging unit whose position and direction are changed, the images being subject to different image quality settings; and a detection section which detects a shielded region, in which imaging is blocked, in the image taken by the imaging unit based on the plurality of images acquired by the acquisition section.

### BRIEF DESCRIPTION OF THE DRAWINGS

In the accompanying drawings:

FIG. 1 is a block diagram showing a configuration of an in-vehicle system; and

FIG. 2 is a flowchart of a shielded region detection process.

### DETAILED DESCRIPTION OF THE PREFERRED EMBODIMENTS

With reference to the accompanying drawings, hereinafter are described embodiments of the present invention.

[Configuration]

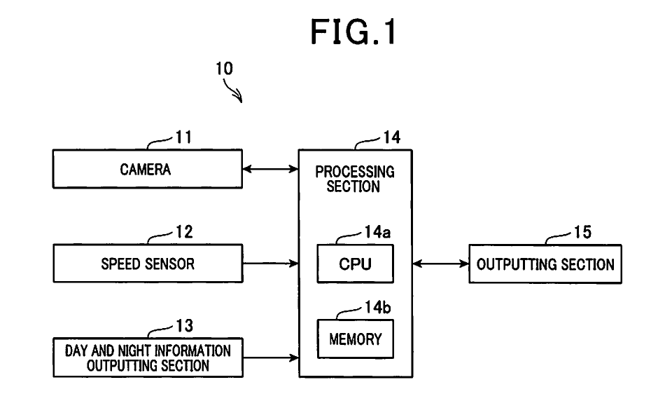

An in-vehicle system 10 (detection apparatus) is installed in a vehicle, and includes a camera 11 (imaging unit), a speed sensor 12, a day and night information outputting section 13, a processing section 14, and an outputting section 15 (see FIG. 1). The in-vehicle system 10 performs driving support based on images (moving image or still images) taken by the camera.

The camera 11 may take images of the periphery of an own vehicle, the periphery including the front of the own vehicle, and provides the taken images to the processing section 14. Note that the position and the direction of the camera 11 may be fixed, or may be changed depending on instructions from the processing section 14.

The speed sensor 12 detects speed of the own vehicle and provides the speed to the processing section 14.

The day and night information outputting section 13 determines whether it is day or night. Specifically, the day and night information outputting section 13 may be an illuminance sensor. In this case, it can be considered that the day and night information outputting section 13 provides illuminance to the processing section 14, and the processing section 14 determines whether it is day or night based on the illuminance.

In addition, the day and night information outputting section 13 may be a switch turning on or off headlights or a light controller controlling the headlights. In these cases, it can be considered that the day and night information outputting section 13 provides an on/off state of the headlights to the processing section 14, and the processing section 14 determines that it is night if the headlights are in an on state, and determines that it is day if the headlights are in an off state.

Note that the in-vehicle system 10 may not include the speed sensor 12 and the day and night information outputting section 13. The in-vehicle system 10 may acquire information provided from the speed sensor 12 and the day and night information outputting section 13 from another ECU via an in-vehicle LAN (not shown) or the like.

The outputting section 15 is configured by, for example, a display unit such as a liquid crystal display, or a speaker, and outputs a range of information according to instructions from the processing section 14.

The processing section 14 integrally controls the in-vehicle system 10, and is configured by a computer including a CPU 14a, an I/O (not shown), and a memory 14b such as a ROM and a RAM. The processing section 14 operates according to a program stored in the memory 14b to realize various functions.

The processing section 14 acquires images around the own vehicle from the camera 11, and generates a range of information for performing driving support based on the images to output the information to the outputting section 15. Note that the processing section 14 may control the brakes, the engine, the steering and the like, which are not shown, based on the images to intervene in driving operation, thereby performing driving support.

[Operation]

In the in-vehicle system 10, the processing section 14 takes four types of images 1 to 4 of different objects by one camera 11 to perform driving support. The object of the image 1 is a pedestrian. The object of the image 2 is a road sign. The object of the image 3 is another vehicle. The object of the image 4 is a white line, a yellow line or the like on the road. Needless to say, other things may be objects of the images.

When taking an image of each object, the processing section 14 sets the image quality so that the object can be accurately recognized from the image. That is, a pedestrian, a road sign, another vehicle, and a white line, a yellow line or the like can be accurately recognized from the images 1 to 4, respectively.

The processing section 14 recognizes a pedestrian around the own vehicle, a road sign ahead of the own vehicle, a vehicle around the own vehicle, and a white line or the like on the road based on the images 1 to 4, respectively. Then, the processing section 14 intervenes in various warnings using the outputting section 15 or the like and the driving support based on the results of the recognition.

The setting of image quality may be a setting concerning the hardware of the camera 11, and a setting concerning the image processing of generating images used for driving support from image data generated by image sensor elements of the camera 11. Note that such image processing is performed by at least one of the camera 11 and the processing section 14.

The setting concerning the hardware may be, for example, settings of F-number of the camera 11, shutter speed (exposure time), ISO speed and the like.

Meanwhile, the setting of image quality concerning the image processing may be settings of parameters concerning, for example, color depth, white balance, a shade, brightness, chroma, contrast, sharpness and the like.

In addition, the in-vehicle system 10 detects a shielded region, in which imaging is prevented by foreign matter, from the image taken by the camera 11.

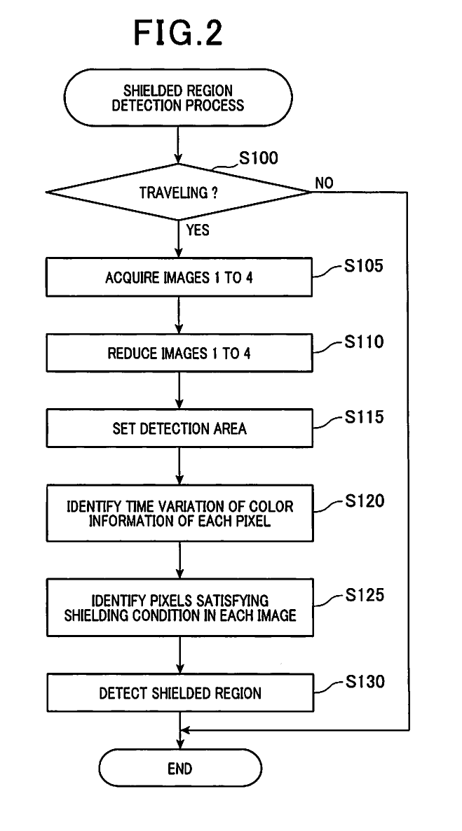

Hereinafter, a shielded region detection process of detecting a shielded region of the image is explained (see FIG. 2). The present process is performed by the processing section 14 at periodical timing.

In step S100, the processing section 14 determines whether or not the own vehicle is traveling based on the speed of the own vehicle acquired from the speed sensor 12. Note that the processing section 14 may determine whether or not the own vehicle is traveling based on the state of the parking brake, the position of the shift lever or the like.

In step S105, the processing section 14 acquires the images 1 to 4 (still images), which have been taken by the camera 11 and subject to image processing by the camera 11 or the processing section 14.

In step S110, the processing section 14 reduces the images 1 to 4 acquired in S105 in predetermined size. The reduction ratio of the image may be determined depending on the size or the shape of the detectable shielded region.

In step S115, the processing section 14 sets a detection area, in which a shielded region is detected, for each of the images 1 to 4. For example, if night is determined by the information provided from the day and night information outputting section 13, the processing section 14 may set an area in the image other than a portion estimated that a night sky is imaged therein (e.g. a lower half area of the image) as the detection area. Needless to say, when setting an area other than the portion estimated that a night sky is imaged therein as the detection area, the detection area can be optionally determined depending on an installation state of the camera 11 or the like. That is, the detection area is not limited to the lower half area of the image.

In step S120, the processing section 14 identifies color information of each pixel forming the detection area, for each of the images 1 to 4. In addition, the processing section 14 updates color information data, which represents time variation of color information of each pixel forming the detection area of each of the images based on the result of the identification.

In step S125, the processing section 14 identifies pixels (sufficient pixels) satisfying a shielding condition over a predetermined period among the pixels forming the detection area of each of the images, based on the color information data of each of the images 1 to 4.

The shielding condition may be a condition (shielding condition 1) that, for example, the color of the corresponding pixel is black (e.g. all the luminances of color components of R, G, B are equal to or less than a threshold value). Note that the threshold value may be a luminance which is approximately half of the maximum luminance. Needless to say, the shielding condition may be a condition that the color of the corresponding pixel is a predetermined color other than black.

Alternatively, the shielding condition may be a condition (shielding condition 2) that, for example, the fluctuation range of the color of the corresponding pixel (e.g. luminances of color components of R, G, B), which is provided from the time when the shielded region detection process is performed previous time, is equal to or less than a threshold value. Note that the processing section 14 may identify pixels satisfying one of the shielding conditions 1 and 2 as the sufficient pixels, or may identify pixels satisfying both the shielding conditions 1 and 2 as the sufficient pixels.

In step S130, the processing section 14 detects shielded region of the images 1 to 4 based on the sufficient pixels satisfied from the respective images 1 to 4. Then, the process ends.

Specifically, the processing section 14 may regard the sufficient pixels identified from all the images 1 to 4 as pixels forming the shielded region. The processing section 14 may regard the sufficient pixels identified from, for example, three or more images 1 to 4 as pixels forming the shielded region.

Then, the processing section 14 calculates the shielded region of each of the images 1 to 4 before reduction, based on the sufficient pixels regarded as forming the shielded region. Specifically, the region where the sufficient pixels are crowded may be regarded as the shielded region. The region surrounded by the sufficient pixels adjacent to each other with the distances equal to or less than a predetermined value may be regarded as the shielded region.

### ADVANTAGES

When foreign matter adheres to the lens of the camera 11, or when foreign matter is placed ahead of the lens, imaging is blocked, and a region (shielded region) always having a predetermined color (e.g. black) arises in the whole or part of the image. Meanwhile, since a shade and the like of the image vary depending on the setting of the image quality, the ranges of such regions differ from each other in a plurality of images whose settings of the image quality differ from each other.

In contrast, according to the in-vehicle system 10 of the above embodiment, in each of the images 1 to 4 whose settings of the image quality differ from each other, sufficient pixels satisfying the shielding condition are identified. In addition, comparing the sufficient pixels identified from the respective images with each other identifies sufficient pixels forming the shielded region. Then, the shielded region in each of the images before reduction is detected based on the sufficient pixels regarded as forming the shielded region.

Thus, since the shielded region is detected in a state where the influence of setting of the image quality is eliminated, the shielded region can be accurately detected, thereby reliably detecting an abnormality of the camera.

In addition, when the position and the direction of the camera 11 are fixed, part of the image does not vary even when imaging is not blocked by foreign matter. Thus, when detecting the shielded region by the shielded region detection process of the above embodiment, if a black region exists in a portion of the image which does not vary, the region may be erroneously detected as the shielded region. In contrast, according to the in-vehicle system 10 of the above embodiment, the shielded region is detected only when the own vehicle is traveling. Hence, the shielded region can be prevented from being erroneously detected.

In addition, when taking images by using the camera 11 at night, the portion of a night sky in the image is always black. Thus, the portion may be erroneously detected as the shielded region. In contrast, according to the above embodiment, when the shielded region detection process is performed at night, detection areas are set in the images 1 to 4 to detect the shielded region for portions of the images where night sky is not imaged. Hence, the portion where night sky is imaged can be prevented from being erroneously detected as the shielded region.

### Other Embodiments

(1) In the above embodiment, the in-vehicle system 10 is exemplified to explain the shielded region detection process of detecting the shielded region based on the images 1 to 4 whose settings of image quality are different from each other. However, even when the present invention is applied to a system taking images by a camera installed in a mobile object other than the vehicle, the similar advantages can be provided. In addition, even when the present invention is applied to a system taking images while changing the direction and the position of the camera, though the present invention is not installed in a mobile object, similar advantages can be provided.

(2) In the shielded region detection process of the above embodiment, the shielded region is detected based on the sufficient pixels identified from the reduced images 1 to 4. However, even when detecting the shielded region based on the sufficient pixels identified from the images 1 to 4 before reduction, similar advantages can be provided.

(3) It will be appreciated that the present invention is not limited to the configurations described above, but any and all modifications, variations or equivalents, which may occur to those who are skilled in the art, should be considered to fall within the scope of the present invention.

(4) In addition to the in-vehicle system 10, the present invention can be achieved in various embodiments including a program for allowing a computer to function as the in-vehicle system 10, a recording medium storing the program, and a method corresponding to the shielded region detection process performed by the in-vehicle system 10.

The in-vehicle system 10 corresponds to one example of the detection apparatus.

The step S105 of the shielded region detection process corresponds to one example of an acquisition section (means). The steps S120 and S125 correspond to one example of an identification section (means). The step S130 corresponds to one example of a detection section (means)

Hereinafter, aspects of the above-described embodiments will be summarized.

As an aspect of the embodiment, a detection apparatus (10) includes: an acquisition section (S105) which acquires a plurality of images taken by an imaging unit (11) whose position and direction are changed, the images being subject to different image quality settings; and a detection section (S130) which detects a shielded region, in which imaging is blocked, in the image taken by the imaging unit based on the plurality of images acquired by the acquisition section.

When foreign matter adheres to a lens of a camera, imaging is blocked, and a region (shielded region) always having a predetermined color (e.g. black) arises in the whole or part of the image. Meanwhile, since a shade and the like of the image vary depending on the setting of the image quality, the ranges of the shielded region may differ from each other in the plurality of images whose settings of the image quality differ from each other.

Thus, by detecting the shielded region based on the plurality of images whose settings of the image quality differ from each other, the shielded region can be accurately detected in a state where the influence of setting of the image quality is eliminated. Accordingly, an abnormality of the image taken by the camera can be reliably detected.

In the detection apparatus, in the image, a region in which a shielding condition regarding color is continuously satisfied is defined as a satisfied region. The acquisition section acquires the images which are subject to each of the image quality settings. The apparatus further includes an identification section (S120, S125) which identifies the satisfied regions of the images, based on the images which are subject to each of the image quality settings. The detection section detects the shielded region based on the satisfied regions identified from the images which are subject to each of the image quality settings.

According to the above configuration, a region (satisfied region) in which imaging is blocked by foreign matter and the like is identified in each of the images which are subject to each of the image quality settings. Then, the shielded region is detected based on the satisfied regions identified by the images. Thus, the shielded region can be accurately detected. Accordingly, any abnormality of the image can be reliably detected.

What is claimed is:

1. A detection apparatus, comprising:
an acquisition section which acquires a plurality of images taken by an imaging unit whose position and direction are changed, the images being subject to different image quality settings; and
a detection section which detects a shielded region, in which imaging is blocked, in the image taken by the imaging unit based on the plurality of images acquired by the acquisition section.

2. The detection apparatus according to claim 1, wherein
in the image, a region in which a shielding condition regarding color is continuously satisfied is defined as a satisfied region,
the acquisition section acquires the images which are subject to each of the image quality settings,
the apparatus further comprises an identification section which identifies the satisfied regions of the images, based on the images which are subject to each of the image quality settings, and
the detection section detects the shielded region based on the satisfied regions identified from the images which are subject to each of the image quality settings.

3. The detection apparatus according to claim 2, wherein
the identification section determines whether or not each pixel of the image continuously satisfies the shielding condition based on the images which are subject to each of the image quality settings, and identifies the pixel, to which positive determination is made, as the satisfied region.

4. The detection apparatus according to claim 1, wherein
the imaging unit is installed in a mobile object.
